(19) United States
(12) Patent Application Publication
(10) Pub. No.: US 2014/0047016 A1
(43) Pub. Date: Feb. 13, 2014

(54) SERVER INFRASTRUCTURE, MOBILE CLIENT DEVICE AND APP FOR MOBILE BLOGGING AND SHARING

(71) Applicant: BINDU RAMA RAO, LAGUNA NIGUEL, CA (US)

(72) Inventor: BINDU RAMA RAO, LAGUNA NIGUEL, CA (US)

(21) Appl. No.: 14/059,018

(22) Filed: Oct. 21, 2013

Related U.S. Application Data
(63) Continuation-in-part of application No. 12/925,417, filed on Oct. 21, 2010.

(51) Int. Cl. H04L 29/08

(52) U.S. Cl. CPC H04L 67/22; H04L 67/02
USPC 709/203

(57) ABSTRACT

A server infrastructure and a mobile client device with a mobile app that facilitates mobile blogging and controlled sharing of blog entries. The mobile client device is communicatively coupled to the server infrastructure and it comprises a registration module configured to receive a registration information from a user and a blog entry module. The mobile app facilitates mobile blogging—High school kids and other users can automatically publish their photos taken on their mobile devices along with voice comments and optional text into a personal profile/blog.

### CROSS REFERENCES TO RELATED APPLICATIONS

The present patent application is a continuation-in-part (CIP) of, claims priority to, and makes reference to United States non-provisional patent, Ser. No. 12/925,417 filed on 21 Oct. 2010, entitled “AUTOMATED BLOGGING AND SKILLS PORTFOLIO MANAGEMENT SYSTEM”, docket number BRRSDJ01201U1. The complete subject matter of the above-referenced United States patent application is hereby incorporated herein by reference in its entirety.

### BACKGROUND

1. Technical Field

The present invention relates generally to blogging; and, more particularly to use of a mobile app for managing and sharing of blog entries with subscribers.

2. Related Art

Cell (mobile) phones are widely used as mobile devices to communicate anywhere in the world. Some of them are very simple devices capable of voice communication alone. Many other today's mobile devices are used for multiple purposes, other than voice communication, in any convenient location. GSM based Cell phones have a SIM card that provides access to cellular networks and support for interactions with a server in a cellular network. These phones also have camera to take photos, and microphones to record voice.

High school kids participate in choir practice, award ceremonies, football teams, lacrosse games, soccer tournaments, track meets—all those events where they take photos on their cell phones. However, after the 50^{th} photo, they forget when individual photos were taken, if they were significant, why they were taken, or who else is in their digital photos. They lose track of their various achievements during their four years in high school, and they have no recollection of any specific events or achievements. They forget the names of their teachers and friends who were in all of those various digital photos. There is no easy way to compile their photos or manage them, or organize them. There is no easy way to share them without making the whole lot of pictures “public”, potentially inviting ridicule from others and nasty comments from people who don't like them. School kids seldom know where their pictures were taken, why they were taken, and you no easy way to assemble recollection of their special moments at school.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a server infrastructure, mobile client device 109 with a mobile app that facilitates mobile blogging and controlled sharing of blog entries.

FIG. 2 is a perspective block diagram of a server infrastructure built in accordance with the present invention.

FIG. 3 is a perspective block diagram of a system with a mobile device comprising a downloadable mobile app that interacts with a server infrastructure to provide mobile blogging facilities.

### DETAILED DESCRIPTION OF THE DRAWINGS

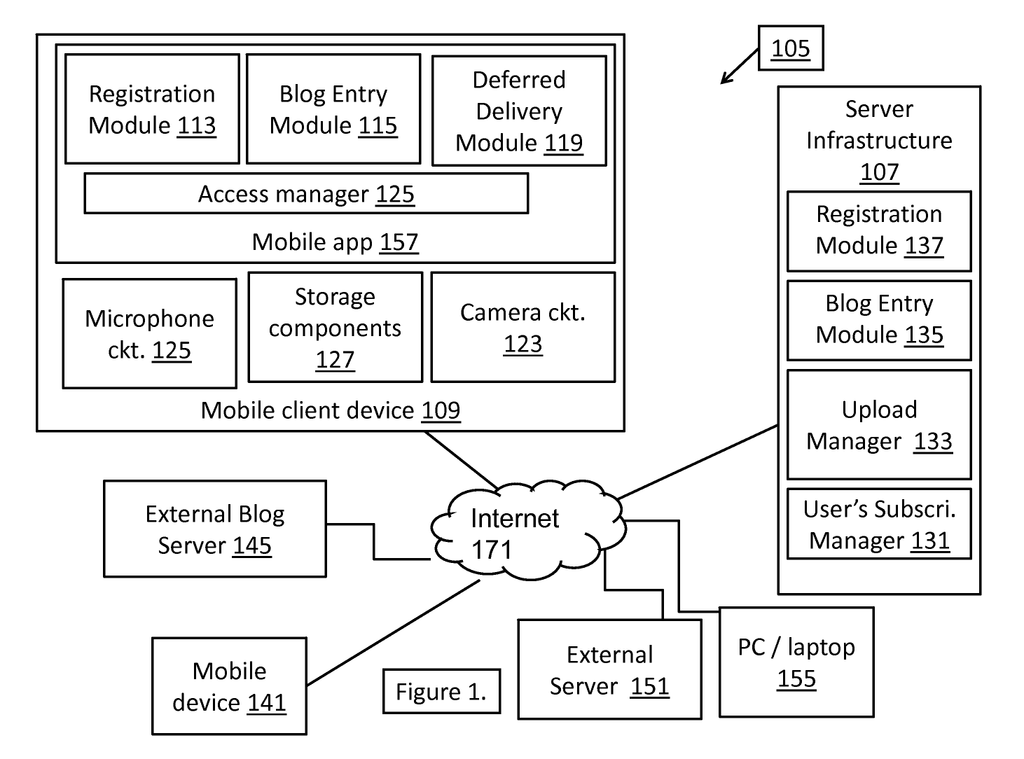

FIG. 1 is a perspective block diagram of a server infrastructure 107, mobile client device 109 with a mobile app 157 that facilitates mobile blogging and controlled sharing of blog entries. The mobile client device 109 is communicatively coupled to a server infrastructure 107 and it comprises a registration module 113 configured to receive a registration information from a user and a blog entry module 115. The registration module 113 is configured to save the registration information locally and to include at least a portion of the registration information as part of any new blog entry created by the user across multiple user sessions. The blog entry module 115 is configured to receive a digital photo or a digital video (recorded using a camera circuitry 123), a voice recording (recorded using a microphone circuitry 125) and a text entry from the user as part of a first new blog entry and communicating it to the server infrastructure 107 for storage and maintenance as a digital asset.

The present invention makes it possible for high school kids (and youth like them) to take photos and videos on their mobile devices (phones, tablets, etc.), blog them in their own blogs that they maintain and share, and control who views them. It makes it possible for them to manage their blog entries, share them only with people they like (parents, siblings, close friends, teachers, grandparents, etc.), or with people who are interested in their achievements (college recruiters, teachers, employers, etc.) curate them, and keep track of the various achievements at school, and various awards received, etc. For example, each blog entry has an associated voice recording that helps provide a context, in their own words, for the photos and videos. Thus, the present invention makes it possible for high school kids and their parents to build and manage a portfolio of photos and videos with voice records for contexts, share them selectively on the Internet or via mobile devices, and manage their portfolios. For example, at school sports events or social events—players and their parents can take photos on their mobile phones, record comments, and post them as a blog entry (with a photo, voice recording and optional text comments, for example).

High school kids and other users can automatically publish their photos taken on their mobile devices along with voice comments and optional text into a personal profile/blog. They can control who views them, and add such viewers as subscribers to their own blog entries. Thus they can easily, from their mobile devices, store their precious memories and share them selectively. For each photo taken, an audio recording can provide a context that is saved, and textual comments can provide some additional details. The combination of the photo taken, audio recording and textual comment form contents of a new blog entry. Similarly, a combination of the video taken, audio recording provided by user and textual comment together forms contents of a another new blog entry.

The blog entry module 115 is also configured to prompt and receive from the user a category information and an event information that the blog entry module includes as part of the first new blog entry. The mobile client device 109 configured to receive the digital photo or a digital video from a camera unit associated with the mobile client device 109. The mobile client device 109 is configured to reduce the size of the digital photo or the digital video if they exceed a corresponding threshold value. The mobile client device 109 is configured to provide a voice recording button that toggles between a START and STOP status thereby providing triggers for starting and stopping voice recording employing a microphone associated with the mobile client device 109.

The mobile client device 109 comprises a deferred delivery module 119 that selectively communicates a digital photo taken, digital video or a voice recording data collected, in deferred mode, to the server infrastructure 107 based on a size associated with the digital photo, digital video and the voice recording data. In deferred mode, the large sized files such as recorded video, large format digital photos, large audio recording, etc. are sent when a network such as WiFi is available where upload times are not long, and those large files can be uploaded quickly and almost freely without becoming cumbersome to a user. Both for cost of upload and for the time taken to upload, deferred mode upload might be preferred by a user, and can be set as default behavior of the deferred delivery module (based on configuration). When a large fle, such as a recorded video is uploaded, a link (such as a URL) or a reference to the uploaded data is received that can be incorporated into a corresponding blog entry. Thus, when the blog entry is uploaded to the server infrastructure 107, the link to the uploaded files are sent in the new blog entry along with a portion of the user registration information (which might be used for authentication purposes, for example).

In a related embodiment, the deferred delivery module 119 selectively communicates a digital photo taken, digital video or a voice recording data collected, in deferred mode, to a server infrastructure 107 based on the availability of an authorized WIFI network (based on 802.11 protocol and its variations such as a/b/n/g etc.) for communications. In another related embodiment, the deferred delivery module 119 selectively communicates a digital photo taken, digital video or a voice recording data collected, in deferred mode, to the server infrastructure 107 based on the availability of an authorized network for communications (any authorized network such as WANS, WiFi based, cellular based, or WiMAX based, etc.). In yet another related embodiment, the deferred delivery module 119 selectively communicates a digital photo taken, digital video or a voice recording data collected, in deferred mode, to a server infrastructure 107 based on the availability of a wifi network. It also communicates a new blog entry to the server infrastructure 107 employing any authorized network currently available (any authorized network such as WANS, WiFi based, cellular based, or WiMAX based, etc.).

In one embodiment, the deferred delivery module 119 sends two parameters in an http post message for uploading user created content such as a photo—one is the actual image data for the digital photo taken and another is a username. It generates a random file name for the image data—for example, every time the mobile app 157 in the mobile client device 109 is started, it comes up with a new random number that is used to seed a random number generator which delivers a random number to be used as part of a file name for the image data.

In one embodiment, the mobile app 157 uploads audio data (and image data, video data, etc.) to the server infrastructure 107 or to an external server, and sets a URI to that uploaded data in the blog entry sent to the server infrastructure 107 for storing. The server infrastructure 107 then optionally converts the URI into appropriate URL and stores it, and retrieves the uploaded data/files as necessary using the URI. In a related embodiment, the mobile app 157 sets complete URLs for the uploaded data into the blog entry, instead of URIs.

In one embodiment, the mobile app 157 performs scaling of digital image taken by a user using the camera circuitry (or selected from an album on the mobile device) to shrink image size (width×height, for example) to a given default size. In a related embodiment, it shrinks them by size (in megabytes, or kilobytes, for example) while keeping the same width and height. In another related embodiment, the mobile app 157 scale images without losing the aspect ratio (i.e. without stretching the image).

In one embodiment, the mobile app 157 records user voice input without any upper limit to the size of the recorded file or to the duration of recording. In a related embodiment, it employs a for a max duration of recording, such as 30 seconds, for user's voice recording for each new blog entry.

In one embodiment, based on availability of streaming file management at the server infrastructure 107, the mobile app 157 facilitates streaming of user voice recording and video recorded by the user. The server infrastructure 107 stores it for access by the user and other subscribers associated with the user in blog entries. In a related embodiment, it supports live streaming of user's voice recording and video recording to all the subscribers associated with that specific user.

Blog entries can be provided an associated category. For example for a high school student, the categories are, in one embodiment, SOCCER, LACROSSE, SOSCA, DRAMA, DANCE, MOCK TRIAL, TRACK, FOOTBALL, CHOIR, OTHER.

The server infrastructure 107 makes it possible for a user to view the blog entries on the website associated with the server infrastructure 107. It makes it possible for a user or subscribers associated with the user to view blog entry lists based on a category selected, or blog entry lists from all the categories. For example, only posts for that user and for that current category selected by that user are listed in category page.

In one embodiment, the user registers with the server infrastructure 107 using a mobile number for a username, and sets up a password and other user information, such as an email address, employing the registration module 137. After registration, the user verifies an email address [provided during registration, by clicking on email sent by server to your registered email address. The user sets up one or more subscribers, such as a school recruiter and a parent, as subscribers, employing the user subscriber's manager accessible through a website provided by the server infrastructure 107. The user uses, for example, a Chrome browser on a mobile device 141 or a PC/laptop 155 to access server infrastructure 107. The user employs “QuickTime” plugin installed and enabled to run in the browser to listen to voice recordings provided for individual blog entries. Using the mobile app 157, after installation on the mobile client device 109, the user configures the mobile app—for example, using the Configure TAB to setup your configuration on a configuration screen provided by the mobile app 157. The user saves the configuration for future use—the user only needs to configure the mobile pp once, by providing, for example, the username, the password, the category selection, event title, etc. The user also, before making blog entries, provides a event title—such as “Homecoming dance”, or “first day of soccer at school”, etc.

For each Blog entry made by the user, the mobile app provides an opportunity to change the title for the blog entry—the user can use a previously saved default title if he so chooses. The user often may elect to change a blog entry title for each new blog entry.

In one embodiment, the server infrastructure 107 facilitates setup of a user account on its website—the user can use a Mobile Number as a login/username. After registration to setup a login account, an email is sent to user with a temporary password server infrastructure 107. The user can use that temporary password to login, then change user's default profile and setup a better/user-friendly password. The server infrastructure 107 allows a user to edit the user profile to change password and other details. The server infrastructure 107 employs an upload manager 133 to receive photos, videos and audio recordings from the deferred delivery module 119 of the mobile app 157 as part of blog entry creation. The blog entry module 135 of the server infrastructure 107 processes new blog entries created by the mobile app 157. It stores details of the new blog entry in a database, as necessary. The user's subscriber manager 131 facilitates specification of subscribers for a given user, access to blog entries for those subscribers, and different modes of sharing with those subscribers.

The mobile app 157 allows the user to configure the blog entry once with all the details requested, using a Configure TAB. The user can provide a login—which is often their mobile number, along with a password and store them using the Configure TAB prompts. For each new blog entry the user makes, an appropriate entry title is provided or a default one is used. The mobile app 157 makes it possible to locally save the configuration (using a SAVE button provided in the Configure TAB) so that the user does not have to enter it again. The mobile app 157 uses an access manager 125 to ensure only authenticated users can conduct blogging, and the right servers and blogs are used for blogging.

After configuration of the mobile app 157 (only once is necessary), the mobile app is ready for mobile blogging—the user can provide blog entries. For example, all that the user has to do is to record a voice message, then take a photo, enter an optional comment in text form using the keyboard on the mobile client device 109 (or soft keys/virtual keyboard), and then hit the Make Blog Entry button. The audio recording is limited to 30 secs of recording by default and can be changed by setting a configuration parameter. Digital photos taken from camera circuitry 123 are compressed by default (can be reconfigured if necessary) to make transfers fast.

In general, to make a new blog entry audio inputs, photo and textual comments are all optional. Only a subset of these may be provided by user, or all three forms of input can be provided, in any new blog entry. For each new entry, all that the user might want to change is a blog entry title, as appropriate. Other values previously configured and saved will be reused unless the user changes them in a configure TAB (or screen).

The exemplary set of user activities for making mobile blog entries are as follows:

a) Registering on the website of the server infrastructure 107 to create a user account that allows mobile blogging

b) Configuring user account information on the CONFIGURE TAB screen on the mobile app 157 in the mobile client device 109

c) Taking a photo, recording voice, enter brief message and posting a new blog entry on the main screen of the mobile app 157 (also labeled the MakeBlogEntry TAB).

d) Reviewing lists of blog entries or individual blog entries on server after login.

After installing the mobile app 157 onto the mobile client device 109 (iphone, ipad, etc.) the user needs to configure the user account—only once is sufficient. This will enable the user to make blog entries. The user's configuration is saved locally in the mobile client device 109 and used as necessary to send blog entries to the server infrastructure 107.

Making new blog entries are easy using the mobile app 157. To take a photo for a blog entry, the user can activate the camera icon on the main screen of the mobile app 157 to use the camera circuitry 123 to take a picture. On the next screen, the user can view the picture view screen, and activate the camera button to take a digital image of the viewed scene. If satisfied with the digital picture taken, the user can select it and return to the main screen. The user can select a photo from the album available in the mobile client device 109 and have it included in a new blog entry. To do this, the user has to select the “From Album” button on the main screen of the mobile app 157 and then select a photo from the album at the next screen. The user can activate the microphone circuitry 125 to record audio—on the main screen of the mobile app 157, the user needs to activate the audio button to use the audio recording feature to provide an audio/voice input. On the next screen, the user can use a BEGIN Recording/STOP Recording toggle button to record an audio message and save it. After entering an audio message or taking a photo and optionally providing a textual input for comments, the user can post a new blog entry by activating the “Make Blog Entry” button. The server infrastructure 107 provides online instructions to the user of the mobile app 157 to help with installation and usage. The main screen on the mobile app 157 also provides an info button ‘i’ that brings up a webpage with user instructions. The server infrastructure 107 online help and FAQ webpage. The user can optionally administer his blog site on the website of the server infrastructure 107.

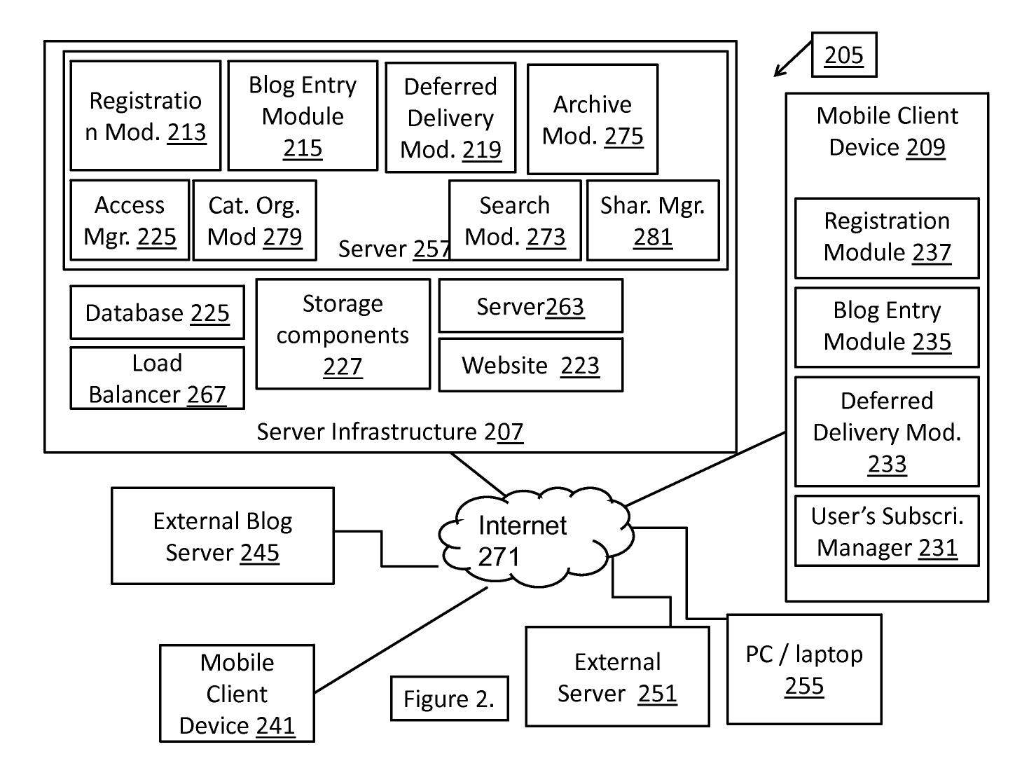

FIG. 2 is a perspective block diagram of a server infrastructure 207 built in accordance with the present invention. The server infrastructure 207 is communicatively coupled to a mobile client device 209 and it comprises a registration module 213 configured to receive at least a portion of the registration information as part of a new blog entry created by a user via the mobile client device 209. It also comprises a blog entry module 215 configured to receive a digital photo or a digital video, a voice recording and a text entry from the user that are associated with a new blog entry, for storage and maintenance as a digital asset. The blog entry module 215 is configured to receive the new blog entry that includes a category information, an event information and references to the photo or a digital video, the voice recording and the text entry. A server 263 is similar to the server 257 in functionality, and the server infrastructure 207 comprises a plurality of servers 257, 263, as necessary, and uses a load balancer 267 as a front-end to the plurality of servers 257, 263. A database 225 is shared by the plurality of servers 157, 163, although, in some embodiments, each server has its own corresponding database (if necessary with the shared database 167 also used as appropriate).

The server infrastructure 207 is configured to retrieve a list of blog entries for a specified user for display on the mobile client device 209 and to to retrieve a user selected blog entry from the list of blog entries for presenting it to a user. It is also configured to provide a user of the mobile client device 209 management capabilities comprising editing, archiving, forwarding, sharing and deleting their own blog entries.

The server infrastructure 207 also comprises a website 223 that is configured to facilitate display of blog entries and management of blog entries by the respective users who are also owners of those blog entries. These users can specify subscribers to their blog entries who get to login as a subscriber (specifying which user or blog they have subscribed to), view those blog entries provided by the corresponding user, and insert comments or recommendations for individual blog entries or general comments about the user.

The server infrastructure 207 further comprises a search module 273 that enables search and retrieval of blog entries by authorized users, and an archive module 275 that presents a list of archived blog entries. It also comprises a category organizer module 279 that presents a user's blog entries by categories, and a sharing manager 281 that lets a user specify subscribers to his blog to share blog entries only with those subscribers, wherein the server infrastructure 207 facilitates sharing of the blog entries with subscribers associated with the user, and addition of comments by those subscribers for that user.

The server infrastructure 207 supports interactions with a plurality of mobile client devices 209, 241. It also provide access to an external blog server 245 where a user can forward his blog entries to, an external server 251 where a user can store or archive the photos, videos, voice recordings, etc. for those blog entries, and a PC/laptop 255 that a user can employ to interact with the website 223.

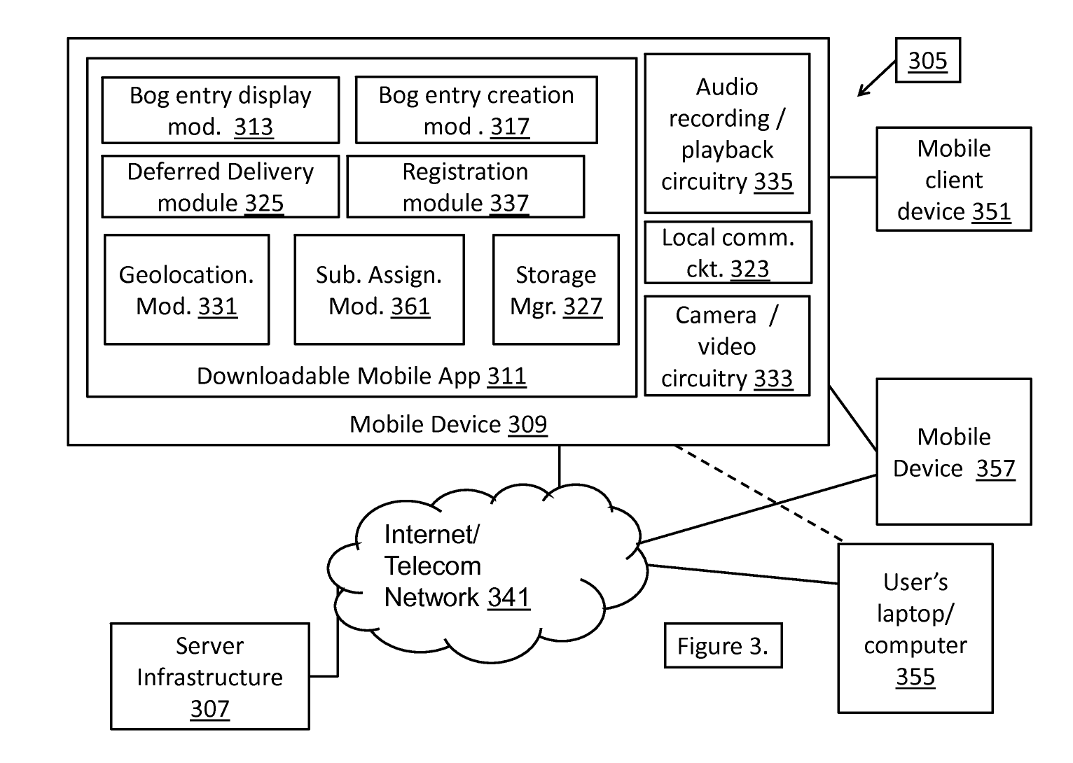

FIG. 3 is a perspective block diagram of a system with a mobile device 309 comprising a downloadable mobile app 311 that interacts with a server infrastructure 307 to provide mobile blogging facilities. The downloadable mobile app 311, in the mobile device 309 communicatively coupled to a server infrastructure 307, comprises a blog entry display module 313 that displays blog entries received from the server infrastructure 307, optionally in a scrollable window, wherein the blog entries comprise a plurality of items and management elements, wherein the management elements comprise sharing, forwarding and deleting. It also comprises a blog entry creation module 317 that facilitates creation of a new blog entry comprising a digital photo or video recording, a voice recording and a textual input entry. The blog entry creation module 317 solicits selection of a category and an event specification for the new blog entry, from a user. A deferred delivery module 325 uploads the digital photo, video or the voice recording data collected to the server infrastructure 307, wherein the upload is made selectively in a deferred mode based on availability of an authorized network for communications and a size associated with corresponding digital photo, video or voice recording data.

The downloadable mobile app 311 also comprises a registration module 337 that facilitates registration of a new user with the server infrastructure 307 and locally saving a registration information for subsequent use during communication of the new blog entry to the server infrastructure 307. The new blog entry made by a user comprise the category, the event specification, a reference or link to the digital photo or video recording, a reference or link to the voice recording and the textual input entry.

The deferred delivery module 337 uploads the digital photo, the video taken or the voice recording to the server infrastructure and retrieves or generates a reference or a link which it subsequently incorporates into the new blog entry. The deferred delivery module 337 uploads the new blog entry to the server infrastructure 307 with links to the digital photo, the video and the voice recording uploaded.

The registration information provided by a user comprises a username and password that the deferred delivery module 325 uses to upload the new blog entry, or subsets thereof, to the server infrastructure 307. The blog entry creation module 317 facilitates creation of a new blog entry and upload of the new blog entry for inclusion in one of a plurality of mobile blogs supported by the server infrastructure 307, wherein the blog entry creation module 317 is configured to support creation of a new blog by the user, before adding blog entries to the new blog subsequently. In one embodiment, it automatically creates a new blog if one does not yet exist, when the user attempts to create a new blog entry.

A geolocation module 331 supplies a geolocation data for inclusion in a new blog entry. A subscriber assignment module 361 facilitates selection of subscribers to a blog of the user using a contact manager (available in the mobile device 309) or the specification of subscribers by the user.

The downloadable mobile app 311 employs a local communication circuitry 311 to communicate a blog entry (or subsets thereof), locally shared with a second mobile client device 351, 357 and with a user's laptop/computer 355. It is also capable of receiving locally shared blog entries from another user's via their corresponding mobile devices 351, 357.

The terms “server” and “server infrastructure” as used herein may refer to a set of computing machines, such as those in data centers, or to a portion of a hosted and managed computing services, that performs multiple underlying computational functions and supports various network access, network storage, data manipulation and searching activities. “Server infrastructure” may also refer to scalable configurations of cloud computing resources with middleware, databases and websites. The term “mobile device” as used herein may refer to handheld computers, tablets, mini-tablets, cell phones, smartphones and personal digital assistants.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A mobile client device communicatively coupled to a server infrastructure, the mobile client device comprising:
a registration module configured to receive a registration information from a user;
the registration module configured to save the registration information locally and to include at least a portion of the registration information as part of any new blog entry created by the user across multiple user sessions;
a blog entry module configured to receive a digital photo or a digital video, a voice recording and a text entry from the user as part of a first new blog entry and communicating it to the server infrastructure for storage and maintenance as a digital asset; and
the blog entry module configured to prompt and receive from the user a category information and an event information that the blog entry module includes as part of the first new blog entry.

2. The mobile client device of claim 1 further comprising:
the mobile client device configured to receive the digital photo or a digital video from a camera unit associated with the mobile client device; and
the mobile client device configured to reduce the size of the digital photo or the digital video if they exceed a corresponding threshold value.

3. The mobile client device of claim 1 further comprising:
the mobile client device configured to provide a voice recording button that toggles between a START and STOP status thereby providing triggers for starting and stopping voice recording employing a microphone associated with the mobile client device.

4. The mobile client device of claim 1 further comprising:
a deferred delivery module that selectively communicates a digital photo taken, digital video or a voice recording data collected, in deferred mode, to the server infrastructure based on a size associated with the digital photo, digital video and the voice recording data.

5. The mobile client device of claim 4 further comprising:
the deferred delivery module that selectively communicates a digital photo taken, digital video or a voice recording data collected, in deferred mode, to the server infrastructure based on the availability of an authorized wifi network for communications.

6. The mobile client device of claim 4 further comprising:
the deferred delivery module that selectively communicates a digital photo taken, digital video or a voice recording data collected, in deferred mode, to the server infrastructure based on the availability of an authorized network for communications.

7. The mobile client device of claim 4 further comprising:
the deferred delivery module that selectively communicates a digital photo taken, digital video or a voice recording data collected, in deferred mode, to the server infrastructure based on the availability of a wifi network; and
the deferred delivery module communicating a new blog entry to the server employing any authorized network currently available.

8. A server infrastructure communicatively coupled to a mobile client device, the server infrastructure comprising:
a registration module configured to receive at least a portion of the registration information as part of a new blog entry created by a user via the mobile client device;
a blog entry module configured to receive a digital photo or a digital video, a voice recording and a text entry from the user that are associated with a new blog entry, for storage and maintenance as a digital asset; and
the blog entry module configured to receive the new blog entry that includes a category information, an event information and references to the photo or a digital video, the voice recording and the text entry.

9. The server infrastructure of claim 8 further comprising:
the server infrastructure configured to retrieve a list of blog entries for a specified user for display on the mobile client device.

10. The server infrastructure of claim 8 further comprising:
the server infrastructure configured to retrieve a user selected blog entry from the list of blog entries for presenting it to a user.

11. The server infrastructure of claim 8 further comprising:
the server infrastructure configured to provide a user of the mobile client device management capabilities comprising editing, archiving, forwarding, sharing and deleting their own blog entries.

12. The server infrastructure of claim 8 further comprising:
a website that is configured to facilitate display of blog entries and management of blog entries by the respective users who are also owners of those blog entries.

13. The server infrastructure of claim 8 further comprising:
a search module that enables search and retrieval of blog entries by authorized users;
an archive module that presents a list of archived blog entries;
a category organizer module that presents a user's blog entries by categories; and
a sharing manager that lets a user specify subscribers to his blog to share blog entries only with those subscribers, wherein the server infrastructure facilitates sharing of the blog entries with subscribers associated with the user, and addition of comments by those subscribers for that user.

14. A downloadable mobile app in a mobile device communicatively coupled to a server infrastructure, the downloadable mobile app comprising:
a blog entry display module that displays blog entries received from a remote server, optionally in a scrollable window, wherein the blog entries comprise a plurality of items and management elements, wherein the management elements comprise sharing, forwarding and deleting;
a blog entry creation module that facilitates creation of a new blog entry comprising a digital photo or video recording, a voice recording and a textual input entry;
the blog entry creation module soliciting selection of a category and an event specification for the new blog entry; and
a deferred delivery module that uploads the digital photo, video or the voice recording data collected to the server infrastructure, wherein the upload is made selectively in a deferred mode based on availability of an authorized network for communications and a size associated with corresponding digital photo, video or voice recording data.

15. The downloadable mobile app of claim 14 further comprising:
a registration module that facilitates registration of a new user with the server infrastructure and locally saving a registration information for subsequent use during communication of the new blog entry to the server infrastructure.

16. The downloadable mobile app of claim 14 wherein the new blog entry comprises the category, the event specification, a reference or link to the digital photo or video recording, a reference or link to the voice recording and the textual input entry.

17. The downloadable mobile app of claim 14 further comprising:
the deferred delivery module uploads the digital photo, the video taken or the voice recording to the server infrastructure and retrieves or generates a reference or a link which it subsequently incorporates into the new blog entry; and
the deferred delivery module uploads the new blog entry to the server infrastructure with links to the digital photo, the video and the voice recording uploaded.

18. The downloadable mobile app of claim 14 further comprising:
the registration information comprises a username and password that the deferred delivery module uses to upload the new blog entry, or subsets thereof, to the server infrastructure.

19. The downloadable mobile app of claim 14 wherein the blog entry creation module facilitates creation of a new blog entry and upload of the new blog entry for inclusion in one of a plurality of mobile blogs supported by the server infrastructure, wherein the blog entry creation module is configured to support creation of a new blog by the user.

20. The downloadable mobile app of claim 14 further comprising:
a geolocation module that supplies a geolocation data for inclusion in a new blog entry; and
a subscriber assignment module that facilitates selection of subscribers to a blog of the user using a contact manager or the or specification of subscribers by the user.
